(19) United States
(12) Patent Application Publication
(10) Pub. No.: US 2010/0134382 A1
(43) Pub. Date: Jun. 3, 2010

(54) Multi-Frequency Antenna

(75) Inventors: Shih-Chia Liu, Taipei County (TW); Tien-Chi Lee, Taipei County (TW); Tsung-Wen Chiu, Taipei County (TW); Fu-Ren Hsiao, Taipei County (TW)

Correspondence Address: SCHMEISER OLSEN & WATTS, 18 E UNIVERSITY DRIVE, SUITE # 101, MESA, AZ, 85201, US

(73) Assignee: Advanced Connectek Inc., Taipei County (TW)

(21) Appl. No.: 12/351,407

(22) Filed: Jan. 9, 2009

(30) Foreign Application Priority Data
Nov. 28, 2008 (TW) 097146169

(51) Int. Cl. H01Q 1/50

(52) U.S. Cl. 343/906

(57) ABSTRACT

A multi-frequency antenna comprises a radiation conductor, a connection interface device, a ground plane, a feeder cable, and an extension conductor. The radiation conductor further comprises a feeder member and a connection member extending serpentinely and far away from the feeder member and having a terminal. One lateral side of the connection interface device is connected to the terminal of the connection member. Another lateral side of the connection interface device is arranged on the ground plane and electrically connected to the ground plane. The present invention adopts a loop-antenna design. In the present invention, a radiation conductor is used to excite a low-frequency resonant mode and a first high-frequency resonant mode, and an extension conductor is used to excite a second high-frequency resonant mode, whereby the antenna system covers several operation frequency bands and features broadband.

### BACKGROUND OF THE INVENTION

1. Field of the Invention

The present invention relates to a multi-frequency antenna, particularly to a multi-frequency antenna integrated with a connection interface.

2. Description of the Related Art

With the fast development of wireless communication, the compact, lightweight, high-sensitivity and low-cost antenna has been the mainstream. Due to the miniaturization design, omnidirectional radiation pattern, capability of mass transmitting audio/video data, and wide frequency band, the multi-frequency antenna is the most widely used antenna among all antenna products.

Referring to FIG. 1, a perspective view of an “Integrated Antenna and Input/Output Port for a Wireless Communication Device” disclosed in a U.S. Pat. No. 7,231,236 is shown, wherein an input/output port 32 is arranged in the lateral of a casing 31 of a wireless communication device to function as an antenna/transmission device, whereby data is transmitted. A cover 33 is used to cover the input/output port 32. The input/output port 32 is a Universal Serial Bus (USB) interface or an Institute of Electrical and Electronics Engineers (IEEE) 1394 interface.

However, the prior-art patent did not describe in details about the frequency band of the application system and the transmission frequency thereof but only mentioned that the input/output port 32 is used as an antenna/transmission element. Such a design is unlikely to excite a plurality of resonant modes to implement a multi-frequency antenna. Besides, using the input/output port 32 as the antenna/transmission device usually causes instability of signal transmission.

### SUMMARY OF THE INVENTION

The primary objective of the present invention is to provide a multi-frequency antenna, wherein a radiation conductor is used to excite a low-frequency resonant mode and a first high-frequency resonant mode, and an extension conductor is used to excite a second high-frequency resonant mode, whereby the antenna system covers several operation frequency bands and features broadband, and whereby the antenna structure is miniaturized.

Another objective of the present invention is to provide a multi-frequency antenna, which adopts a loop-antenna design, wherein the radiation conductors and the extension conductor are fabricated to have a serpentine layout, whereby the antenna structure is simplified, and the antenna size is greatly reduced, wherefore the antenna system of the present invention is easy to assemble for various electronic devices, and the cost thereof is decreased.

A further objective of the present invention is to provide a multi-frequency antenna, wherein the grounding conductor of the USB interface is used as the grounding connection interface of the antenna system to reduce the interference on signal transmission and promote the stability of signal transmission.

To achieve the abovementioned objectives, the present invention proposes a multi-frequency antenna, which comprises a radiation conductor, a connection interface device, a ground plane, a feeder cable, and an extension conductor. The radiation conductor further comprises a feeder member and a connection member extending serpentinely and far away from the feeder member and having a terminal. One lateral side of the connection interface device is connected to the terminal of the connection member. Another lateral side of the connection interface device is arranged on the ground plane and electrically connected to the ground plane. The feeder cable further comprises a central wire connected to the feeder member and an external conductive layer connected to the ground plane. The extension conductor is connected to the radiation conductor, extends far away from the feeder member and has a terminal, wherein the connection member's terminal closely neighbors the extension conductor's terminal but does not physically contact the extension conductor's terminal.

The present invention fabricates the radiation conductor to have a serpentine form to greatly increase the resonant path of the antenna and reduce the space occupied by the antenna. The present invention uses the grounding conductor of the USB interface as the grounding connection interface of the short-circuit member of the antenna system. The signal starts from the feeder member of the radiation conductor through the connection member to the grounding conductor of the USB interface and then to the ground plane of the antenna system. Thus, the radiation conductor and the grounding conductor of the USB interface are integrated into an antenna loop, which can excites a low-frequency resonant mode and a first high-frequency resonant mode. Further, the radiation conductor cooperates with the extension conductor to excite a second high-frequency resonant mode. Besides, the terminal of the extension conductor and the terminal of the connection member are close to each other and have a gap therebetween, which generates a capacitive coupling effect to modulate the impedance matching of the second high-frequency resonant mode. The first and second high-frequency resonant modes jointly form a broadband resonant mode, whereby the antenna system covers several operation frequency bands and has a characteristic of broadband. Therefore, the present invention can overcome the conventional problem that antenna miniaturization always accompanies insufficiency of frequency bands. The integrated loop antenna design and the simple layouts of the radiation conductor and the extension conductor simplify the antenna structure and decrease the antenna size, whereby the space occupied by the antenna is greatly reduced, and the antenna system can be easily assembled into various electronic products. Thus is reduced the fabrication cost.

Below, the embodiments are described in detail to make easily understood the technical contents of the present invention.

### BRIEF DESCRIPTION OF THE DRAWINGS

FIG. 1 is a perspective view of an “Integrated Antenna and Input/Output Port for a Wireless Communication Device” disclosed in a U.S. Pat. No. 7,231,236;

FIG. 2 is a perspective view of a multi-frequency antenna according to one embodiment of the present invention;

FIG. 3 is a perspective view of the present invention from another angle of view;

FIG. 4 is a partially enlarged view of the conductors and the connection interface device according to one embodiment of the present invention; and

FIG. 5 is a diagram showing the measurement results of the return loss of the antenna system according to one embodiment of the present invention.

### DETAILED DESCRIPTION OF THE INVENTION

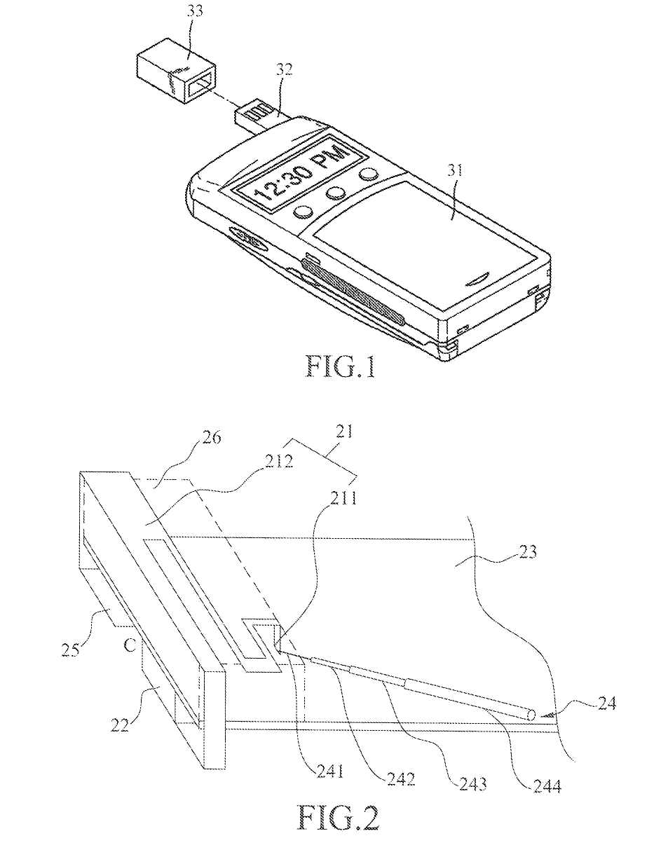

Referring to FIG. 2, a perspective view of a multi-frequency antenna according to one embodiment of the present invention is shown. The multi-frequency antenna of the present invention comprises a radiation conductor 21, a connection interface device 22, a ground plane 23, a feeder cable 24, and an extension conductor 25. The radiation conductor 21 further comprises a feeder member 211 and a connection member 212. The feeder cable 24 further comprises a central wire 241, an insulation layer 242, an external conductive layer 243 and a coating layer 244.

A microwave dielectric material 26 is used to support the radiation conductor 21 formed over the ground plane 23. The microwave dielectric material 26 is a non-metallic material and used to prevent the radiation conductor 21 from contacting the ground plane 23. The connection member 212 of the radiation conductor 21 extends serpentinely and far away from the feeder member 211 and has a terminal (not shown in the drawings). One lateral side of the connection interface device 22 is connected to the terminal of the connection member 212. The other lateral side of the connection interface device 22 is arranged on the ground plane 23 and electrically coupled to the ground plane 23. The connection interface device 22 may be a USB interface or an IEEE1394 interface. The central wire 241 of the feeder cable 24 is connected to the feeder member 211 and conducts the high-frequency signal to the feeder member 211. The external conductive layer 243 of the feeder cable 24 is connected to the ground plane 23. The extension conduction 25 connects with the radiation conductor 21, extends far away from the feeder member 211 and has a terminal. The terminal of the connection member 212 closely neighbors the terminal of the extension conductor 25. The terminal of the connection member 212 does not contact the terminal of the extension conductor 25 but is separated from the terminal of the extension conductor 25 by a gap C. The connection member 212 and the extension conductor 25 do not contact the ground plane 23 but keep a gap to the ground plane 23. The gap C between the terminal of the connection member 212 and the terminal of the extension conductor 25 is used to generate a capacitive coupling effect, whereby the transmission efficiency of the radiation conductor 21 is improved.

The connection member 212 of the radiation conductor 21 has a serpentine form. The front portion of the connection member 212 has a thickness of about 1 mm, and the rear portion has a thickness of about 3.5 mm. The connection interface device 22 has a length of about 6 mm, a width of about 7 mm and a height of about 2.5 mm. The extension conductor 25 is bent to have an L shape and contains two rectangles; the first rectangle has a length of about 9 mm and a width of about 3.5 mm; the second rectangle has a length of 14 mm and a width of about 3.5 mm. The microwave dielectric material 26 has a length of about 45 mm, a width of 14 mm and a height of about 5 mm.

In this embodiment, the serpentine form of the radiation conductor 21 is used to increase the resonant path of the antenna. The radiation conductor 21 and the grounding conductor of the USB interface are integrated into a loop antenna, whereby the antenna system covers several operation frequency bands and features broadband. The simple layout of the radiation conductor 21 and the extension conductor 25 simplifies the antenna structure and reduces the antenna size. Thereby, the multi-frequency antenna of the present invention is easy to assemble and has a lower cost.

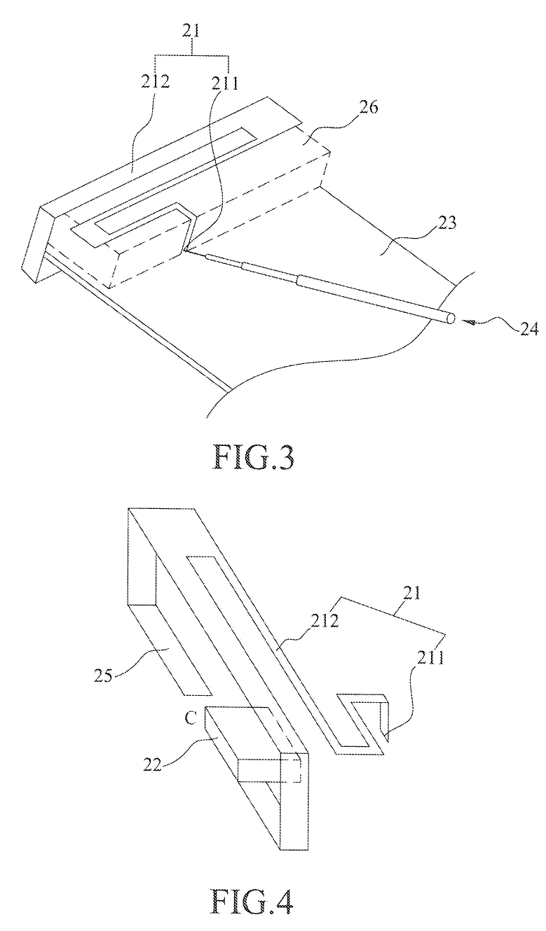

Referring to FIG. 3, a perspective view of the present invention from another angle of view is shown. The microwave dielectric material 26 is arranged on the surface of the ground plane 23 and supports the radiation conductor 21. Both sides of the radiation conductor 21 protrude from the microwave dielectric material 26. Therefore, the connection member 212 extending from the two sides and the extension conductor 25 does not contact the ground plane 23. The microwave dielectric material 26 is a non-metallic material. Therefore, the microwave dielectric material 26 can prevent the electric conduction caused by the contact of the metallic radiation conductor 21 and the metallic ground plane 23 lest the radiation transmission efficiency of the antenna system be decreased.

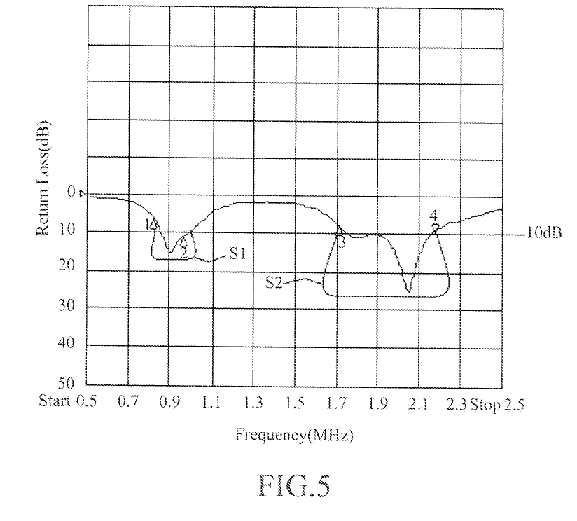

Referring to FIG. 4, a partially enlarged view of the conductors and the connection interface device according to one embodiment of the present invention is shown. The connection member 212 of the radiation conductor 21 is designed to have a serpentine form, whereby the layout dimensions of the radiation conductor 21 is reduced. Based on the design concept of the loop antenna, the extension conductor 25 is bent to have an L shape, whereby the volumes of the radiation conductor 21 and the extension conductor 25 are greatly reduced. Besides, the internal signal transmission conductor of the USB interface is used as the grounding connection interface of the short-circuit member of the antenna system to reduce the interference on signal transmission.

Referring to FIG. 5, a diagram shows the measurement results of the return loss of the antenna system according to one embodiment of the present invention, wherein the horizontal axis represents frequency, and the vertical axis represents dB. When the operation frequency bands of the antenna system are defined by the return loss greater than 10 dB, there are an operation frequency band S1 ranging from 824 to 960 MHz, which covers the AMPS system (824-894 MHz) and GSM system (880-960 MHz), and an operation frequency band S2 ranging from 1710 to 2170 MHz, which covers the DCS system (1710-1880 MHz), PCS system (1850-1990 MHz) and UMTS system (1920-2170 MHz).

The present invention possesses utility, novelty and non-obviousness and meets the condition for a patent. The embodiments described above are only to exemplify the present invention but not to limit the scope of the present invention. Any equivalent modification or variation according to the spirit of the present invention is also included within the scope of the present invention.

What is claimed is:

1. A multi-frequency antenna comprising:
a radiation conductor further comprising;
a feeder member; and
a connection member extending serpentinely and far away from said feeder member and having a terminal;
a connection interface device with one lateral side thereof connected to said terminal of said connection member;
a ground plane electrically connected to another lateral side of said connection interface device, which is arranged on said ground plane;
a feeder cable further comprising
a central wire connected to said feeder member; and
an external conductive layer connected to said ground plane;
an extension conductor connected to said radiation conductor, extending far away from said feeder member and having a terminal, wherein said connection member's terminal closely neighbors said extension conductor's terminal but does not physically contact said extension conductor's terminal.

2. The multi-frequency antenna according to claim 1, wherein a microwave dielectric material supports said radiation conductor to form over said ground plane.

3. The multi-frequency antenna according to claim 2, wherein said microwave dielectric material is a non-metallic material.

4. The multi-frequency antenna according to claim 1, wherein said connection member and said extension conductor keep a gap to said ground plane.

5. The multi-frequency antenna according to claim 1, wherein said connection interface device is a Universal Serial Bus ( USB) interface.

6. The multi-frequency antenna according to claim 1, wherein said connection interface device is an Institute of Electrical and Electronics Engineers (IEEE) 1394 interface.
